(19) United States
(12) Patent Application Publication
(10) Pub. No.: US 2024/0399260 A1
(43) Pub. Date: Dec. 5, 2024

(54) RECORDING MEDIUM AND INFORMATION PROCESSING DEVICE FOR VIDEO GAME

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 18/804,527

(22) Filed: Aug. 14, 2024

Related U.S. Application Data
(63) Continuation of application No. PCT/JP2023/002075, filed on Jan. 24, 2023.

(30) Foreign Application Priority Data
Feb. 15, 2022 (JP) 2022-021212

(51) Int. Cl. A63F 13/795; A63F 13/35; A63F 13/87

(52) U.S. Cl. CPC A63F 13/795; A63F 13/35; A63F 13/87

(57) ABSTRACT

A non-transitory computer readable recording medium storing instructions for a video game that cause a computer to execute: receiving an input signal from a first player for forming a party consisting of one or more pieces of game content; in response to a second player employing the formed party, identifying the first player who formed the formed party; and in response to the second player employing the formed party, and in response to a third player also employing the formed party after being employed by the second player, granting a reward to the identified first player.

### BACKGROUND

### Technical Field

The present invention relates to a recording medium storing instructions and an information processing device for video games.

### Description of Related Art

Conventional video games include games in which a player uses a party formed from a plurality of usable characters to play a battle game (such as a quest).

On this topic, Patent Literature 1 discloses a technique with which a player can receive guidance from a friend player about forming a party using characters owned by the player.

### PATENT LITERATURE

Patent Literature 1: Japanese Patent No. 6135812

### TECHNOLOGICAL PROBLEM TO BE SOLVED BY THE INVENTION

In such conventional gaming technology, players can employ (copy) a party formed by another player in their own party, so each player can play the game with a wide variety of parties. However, a player (the forming player) whose formed party has been propagated to multiple players receives no incentives corresponding to such propagation, and therefore ends up losing their motivation to play the game.

### SUMMARY

One or more embodiments of the present invention provide a recording medium storing instructions and an information processing device that grant a reward with a specific algorithm to a player whose formed party has been propagated.

The non-transitory computer readable recording medium storing instructions for a video game according to a first mode of the present invention causes a computer to execute: receiving an input signal from a first player for forming a party consisting of one or more pieces of game content: in response to a second player employing the formed party, identifying the first player who formed the formed party; and in response to the second player employing the formed party, and in response to a third player also employing the formed party after being employed by the second player, granting a reward to the identified first player.

Also, in a second mode of the present invention, the identifying includes identifying the first player in response to a request from the second player to copy the formed party, and in response to a request from the third player to copy the employed party.

Also, in a third mode of the present invention, the identifying includes identifying the first player in response to the second player browsing the formed party and then forming the formed party in their own party, and the identifying includes identifying the first player in response to the third player browsing the employed party and then forming the employed party in their own party.

Also, in a fourth mode of the present invention, the identifying includes identifying the first player in response to the second player playing a battle game with the formed party and then forming the formed party in their own party, and the identifying includes identifying the first player in response to the third player playing a battle game with the employed party and then forming the employed party in their own party.

Also, in a fifth mode of the present invention, the granting includes granting the reward to the first player in response to the second player playing a battle game using the employed party, or in response to the third player playing a battle game using the employed party.

Also, in a sixth mode of the present invention, the granting includes granting the reward to the first player in response to the second player winning a battle game using the employed party, or in response to the third player winning a battle game using the employed party.

Also, in a seventh mode of the present invention, the granting includes granting a first reward in response to the second player employing the formed party as an employed party, and granting a second reward different from the first reward in response to the third player employing the employed party.

Also, in an eighth mode of the present invention, the first reward is of greater value than the second reward.

Also, in a ninth mode of the present invention, the second reward is of greater value than the first reward.

Also, the information processing device for a video game according to a tenth mode of the present invention comprises: a central processing unit (CPU) that: receives an input signal from a first player for forming a party consisting of one or more pieces of game content, in response to a second player employing the formed party, identifying the first player who formed the formed party, and in response to the second player employing the formed party, and in response to a third player also employing the formed party after being employed by the second player, grants a reward to the identified first player.

With one or more embodiments of the present invention, the reward is granted with a specific algorithm to a player whose formed party has been propagated.

### BRIEF DESCRIPTION OF THE DRAWINGS

FIG. 1 is a block diagram showing an example of the overall configuration of a game system according to a first embodiment;

FIG. 2 is a diagram schematically showing an example of the hardware configuration of a server device;

FIG. 3 is a diagram showing an example of the hardware configuration of a smartphone, as the terminal device shown in FIG. 1;

FIG. 4 is a block diagram showing an example of the functional configuration of a server device;

FIG. 5 is a flowchart showing an example of the flow of processing performed by each of functional units shown in FIG. 4 in the game system according to the first embodiment;

FIG. 6 is a diagram showing an example of a cooperating player details screen according to the first embodiment;

FIG. 7 is a diagram showing an example of a reward receipt screen according to the first embodiment;

FIG. 8 is a flowchart showing an example of the flow of processing performed by each of functional units in the game system according to a second embodiment; and

FIG. 9 is a diagram showing an example of a reward receipt screen according to the second embodiment.

### DETAILED DESCRIPTION

A number of embodiments of the present invention will now be described with reference to the appended drawings. To facilitate understanding of the description, components and steps that are the same will be numbered the same as much as possible in the drawings, and redundant description will be omitted.

### First Embodiment

A first embodiment will be described now.

### Overall Configuration

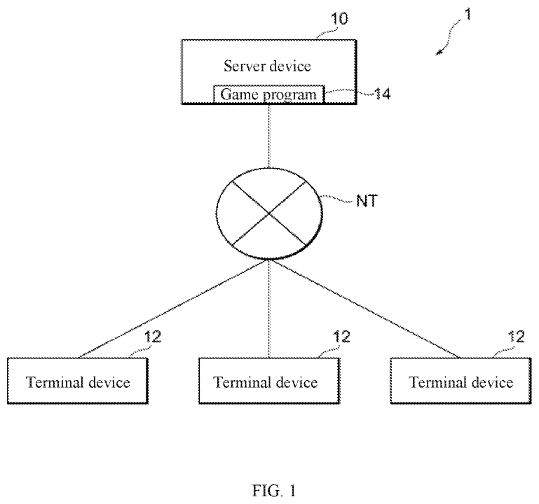

FIG. 1 is a block diagram showing an example of the overall configuration of a game system 1 according to the first embodiment.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of the game obtained by executing instructions including a game program 14, or the instructions themselves, to the player of each terminal device 12 via the communication network NT. In the first embodiment, the server device 10 provides the instructions themselves to the players of the terminal devices 12.

Each terminal device 12 is an information processing device belonging to a player, and is an information processing device that provides a game to a player by executing the instructions received from the server device 10 after the instructions have been installed. Examples of these terminal devices 12 include video game machines, arcade game machines, mobile phones, smartphones, tablets, personal computers, and various other such devices.

### Hardware Configuration

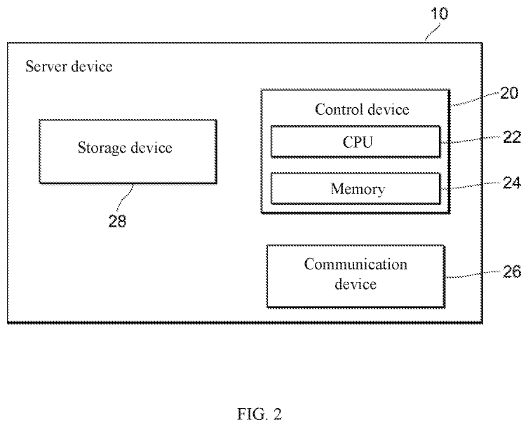

FIG. 2 is a diagram schematically showing an example of the hardware configuration of the server device 10.

As shown in FIG. 2, the server device 10 comprises a control device 20, a communication device 26, and a storage device 28. The control device 20 mainly comprises a CPU (central processing unit) 22 and a memory 24.

In the control device 20, the CPU 22 functions as various functional units by executing specific instructions stored in the memory 24, the storage device 28, or the like. These functional units will be described in detail below.

The communication device 26 is constituted by a communication interface or the like for communicating with an external device. The communication device 26 sends and receives various kinds of information to and from the terminal device 12, for example.

The storage device 28 is constituted by a hard disk or the like. The storage device 28 stores various kinds of instructions and various kinds of information necessary for executing processing in the control device 20, including the instructions, as well as information about processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for further comprising an operating device, a display device, and a sound output device, for example.

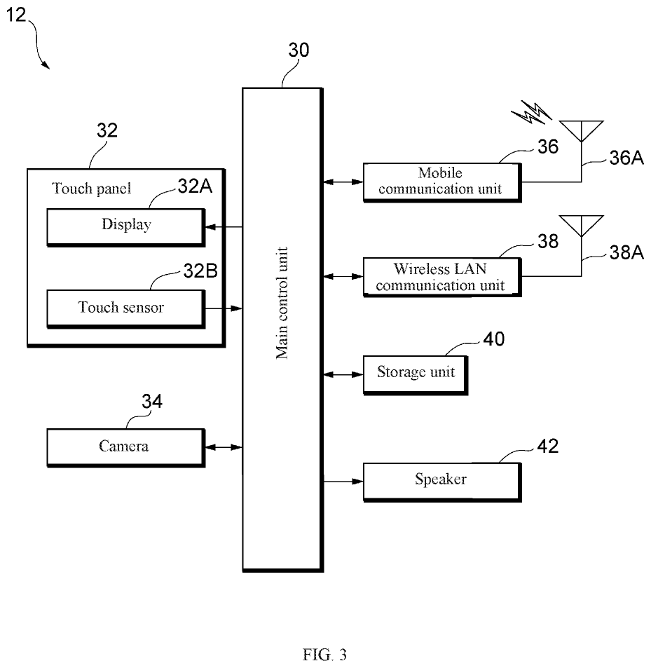

FIG. 3 is a diagram showing an example of the hardware configuration of a smartphone serving as the terminal device 12 shown in FIG. 1.

As shown in FIG. 3, the terminal device 12 comprises a main control unit 30, a touch panel (touch screen) 32, a camera 34, a mobile communication unit 36, a wireless LAN communication unit 38, a storage unit 40, and a speaker 42.

The main control unit 30 includes a CPU, a memory, and so forth. This main control unit 30 is connected to the touch panel 32 (used as a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In the first embodiment, the display 32A can display game images including button images, a cross key image, a joystick image, and other such operation input images. The touch sensor 32B can sense the input position of the player with respect to a game image.

The camera 34 has the function of capturing still and/or moving images and storing these images in the storage unit 40.

The mobile communication unit 36 is connected to a mobile communication network via an antenna 36A, and has the function of communicating with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of instructions and data, such as the game program 14, and play data indicating player information or the progress of the game in the instructions. This play data may be stored in the server device 10.

The speaker 42 has the function of outputting game sounds and so forth.

### Game Overview

Games according to the first embodiment include lottery games, quests, and so forth, in which a player can acquire characters (an example of content). These lottery games are sometimes referred to as gacha (loot box), raffle, summoning, or the like. These quests are sometimes referred to as battle games, dungeons, searches, or the like.

A lottery game according to the first embodiment is a game in which one or more characters (pieces of content) are chosen (randomly selected) from a lottery target character group (lottery target content group) serving as a lottery target upon an execution request (instruction) from the player to execute a lottery game and provided to the player. This lottery game is executed based on the consumption of game currency owned by the player.

This game currency may include, for example, paid currency and unpaid currency. Paid currency is paid content that can be acquired by a purchase procedure (payment) using money, a prepaid card, a credit card, electronic money, crypto assets, or the like. Examples of paid currency include, for example, charged items (paid items), charged coins (paid coins), charged points (paid points), and so forth. For example, in the game according to the first embodiment, charged items may be purchased for 100 yen for one item. On the other hand, unpaid currency is unpaid content that can be acquired by executing a game. Examples of unpaid currency include non-charged items (unpaid items), non-charged coins (unpaid coins), non-charged points (unpaid points), and so forth. Examples of executing a game may include the player logging into the game, winning in a quest, and completing a mission. Unpaid currency can be consumed in the same way as paid currency in various kinds of games. For example, in the first lottery game according to the first embodiment, charged items and non-charged items may be consumed with no distinction between the two.

Also, a quest according to the first embodiment is, for example, a multiplayer battle game (cooperative game) in which a party of one player and a party of another player (cooperating player) that has been matched with the one player cooperate to battle against enemy characters.

For example, a player can form a party by randomly selecting (with a selection instruction) one or more pieces of game content, e.g., a specific number of characters (e.g., four) from among the characters possessed by the player from a formation menu for forming a party. Also, a player may employ (e.g., copy) a party from a different player.

This quest is executed based on the consumption of the current stamina value associated with the player who is serving as the host of the multiplayer game. This current stamina value is recovered through the consumption of game currency (paid currency or unpaid currency). Quests are carried out based on the ability parameters of the characters that constitute each player's party and the ability parameters of enemy characters. Each player that participates in a quest can acquire a clearance reward (reward content) if they defeat a boss character that appears in the quest (clear the quest), that is, when the hit points of the boss character fall to zero or less. Examples of this clearance reward include unpaid currency, gacha tickets, characters, player experience points, and so forth.

### Functional Units

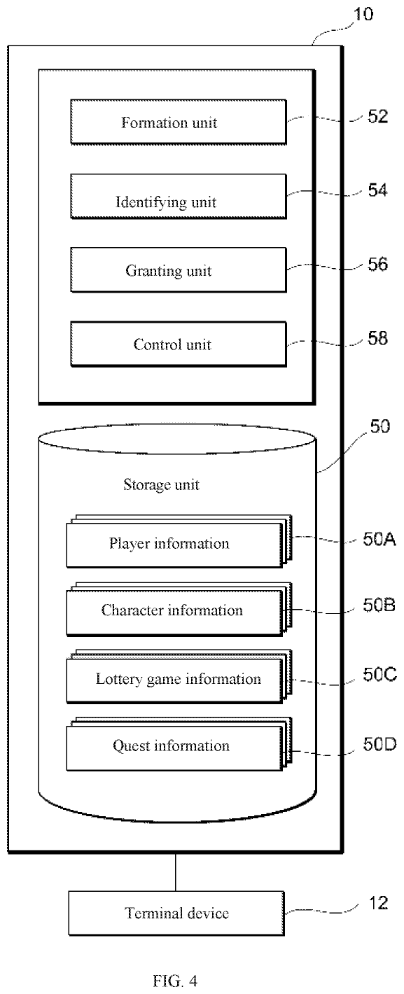

FIG. 4 is a block diagram showing an example of the functional configuration of the server device 10.

As shown in FIG. 4, the server device 10 comprises, as functional components, a storage unit (or storage) 50, a formation unit 52, a identifying unit 54, a granting unit 56, and a control unit 58. The storage unit 50 is realized in the form of one or more storage devices 28. Functional units other than the storage unit 50 are realized when the control device 20 executes the instructions stored in the storage device 28 or the like.

The storage unit 50 is a functional unit for storing player information 50A, character information 50B, lottery game information 50C, quest information 50D, and so forth.

Player information 50A is stored for each player in association with the player ID of that player. This player information 50A includes, for example, the player's name, age, player rank, possessed content information, party information, matching history, stamina information, and so forth.

The player rank increases when the player acquires player experience points, for example.

Possessed content information includes possessed character information, possessed item information, and so forth. Possessed character information includes the character ID and quantity of the characters possessed by the player. Possessed item information includes the type and quantity of the items possessed by the player. Examples of these items include charged items, non-charged items, stamina restoration items, and so forth.

Party information includes the character IDs of the characters that constitute one party used by a player in a quest, and forming player IDs.

A forming player ID includes the player ID of the player who formed the party (the forming player). For example, when a player forms their own party, the forming player ID corresponding to that player will include that player's own player ID. On the other hand, when a second player employs a formed party formed by the first player (the forming player), the forming player ID corresponding to that second player will include the player ID of the first player. Here, since the forming player ID corresponding to the second player includes a player ID different from the player ID of the second player, the second player becomes an employing player.

Even if a third player further employs the employed party of a second player (employing player) as an employed party, the forming player ID corresponding to the third player will include the player ID of the first player. That is, the forming player ID includes the player ID of the player who originally formed the party, even if that party has been employed a number of times. Here, since the forming player ID corresponding to the third player includes a player ID different from the player ID of the third player, the third player becomes an employing player.

Examples of this employment include copying (duplicating) all the characters that constitute a party, or forming a party by imitation (replicating). For example, a formed party may be a party consisting of a specific number of characters (e.g., four) (pieces of content) selected (with a selection instruction) by the player from among the plurality of possessed characters (pieces of content). In other words, a “formed party” refers to a party that the player has thought up and created (formed) on their own without employing another player's party. Meanwhile, an “employed party” is a party that employs (e.g., copies) a party (formed party) that was formed by a different player. Here, an employed party includes not only a party that has been directly employed from a formed party, but also a party that this directly employed party (employed party) has employed one or more times.

The matching history includes the player ID and party of each matched player for each quest that the player has played in the past. This party includes the character IDs of the characters that constitute the party used by the matched player in a quest.

Stamina information includes the current stamina value or the stamina upper limit value, and the stamina restoration amount. The current stamina value is the value consumed when the player executes a quest within the game. This current stamina value is restored by a specific amount (such as 1) after a certain period of time (such as 3 minutes) elapses, and is restored up to the stamina upper limit value. The stamina upper limit value is the upper limit value to which the current stamina value can be restored over time or through restoration processing. The stamina upper limit value may increase along with the player rank, for example. The stamina restoration amount includes the amount (such as 10) by which the current stamina value is restored through restoration processing, for example. This restoration processing is carried out through the consumption by the player of game currency (such as a charged item) or a stamina restoration item. This stamina restoration amount increases by a specific amount (such as 1) when, for example, the player rank goes up by 1.

Character information 50B is stored for each character in association with the character ID of that character. The character information 50B may include, for example, the character name and image, ability parameters, special skills, and rarity. This character information 50B is updated from time to time through a game update (a version upgrade or update) by the game operator.

Ability parameters include attack power, defense power, hit points, and so forth.

Special skills include effects that are activated during a quest. Examples of these effects include the effect of inflicting damage on an enemy character by one of the characters constituting the party, the effect of changing the ability parameters of a character constituting one's own party, and the effect of changing the ability parameters of a character constituting a cooperating player's party. For example, a player may form a party based on the compatibility of the characters' special skills.

Rarity may be represented by any number from 1 to 6, for example. This number may be indicated by a number of stars, for example. A character with a high rarity may be set, for example, with an ability parameter or special skill that is advantageous in a quest.

Lottery game information 50C is stored for each lottery game in association with the lottery game ID of that lottery game. The lottery game information 50C includes the lottery game name and cost, lottery target information, and so forth.

Cost includes the amount of game currency (paid currency or unpaid currency) required to execute one lottery. For instance, the cost for the first lottery game may be five charged items or five non-charged items.

Lottery target information includes the character IDs of the characters constituting the lottery target character group that is the lottery target of a lottery game, and the appearance frequency (weighting) associated with that character ID. Appearance frequency may be represented by any number from 1 to 10, for example. The appearance frequency is set to a low numerical value for a character with a high rarity, and to a high numerical value for a character with a low rarity. The appearance frequency may be set to different numerical values among characters of the same rarity (such as a rarity of 6). Here, the probability of drawing one character is a value obtained by dividing the appearance frequency set for that one character by the total value of the appearance frequencies set for each of the characters that constitute the lottery target character group. More specifically, if the appearance frequency set for one character is 2 and the total value of the appearance frequencies set for each of the characters that constitute the lottery target character group is 400, the probability of drawing that one character is 2/400 (0.5%).

Quest information 50D is stored for each quest in association with the quest ID of that quest. The quest information 50D includes the quest name, consumed stamina value, enemy character information, clearance rewards, drop rate, and so forth.

Consumed stamina value includes the value required to execute the quest. Consumed stamina value is consumed from the player's current stamina value. The higher the difficulty of the quest, the higher the consumed stamina value may be, for example.

Enemy character information includes character IDs of the enemy characters that appear in a quest. These enemy characters include a boss character.

Clearance rewards include non-charged items, gacha tickets, characters, stamina restoration items, and so forth.

Drop rate includes, for example, the probability that the player will earn a clearance reward (e.g., a character).

The formation unit 52 is a functional unit for forming a party. In the first embodiment, the formation unit 52 forms a party consisting of a specific number of characters (e.g., four) selected by the player from among the plurality of characters (pieces of content) possessed by the player. For example, the formation unit 52 stores the character IDs of all the characters constituting the party formed by the player in the character ID field of the party information in the player information 50A. Next, the formation unit 52 stores the player ID of the player who formed the party in the forming player ID field of that party information.

Also, the formation unit 52 employs (e.g., copies) a party in response to a request from one player to employ (e.g., copy) a party (formed party or employed party) of another player. For example, in response to the request, the formation unit 52 copies the party information (character ID and forming player ID) in the player information 50A of another player for the party information (character ID and forming player ID) in the player information 50A of the one player.

The identifying unit 54 is a functional unit for identifying the forming player who formed the party. In the first embodiment, when one player employs a formed party formed by a certain player (the forming player) as an employed party in their own party, the identifying unit 54 identifies that certain player (the forming player) who formed that formed party. Furthermore, the identifying unit 54 also identifies the certain player (the forming player) even when another player further employs the employed party that was employed by the one player (employing player) as an employed party in their own party. In other words, the identifying unit 54 also identifies the certain player (the forming player) who formed the formed party not only when that formed party is employed as an employed party, but also when this employed party is further employed. More specifically, when one player employs a party of another player, the identifying unit 54 identifies the forming player (forming player ID) by referring to the party information in the player information 50A of that other player. This allows the forming player to receive a reward (employment reward) even when the party he formed has been propagated.

For example, the identifying unit 54 identifies the forming player when there is a request from one player to employ a formed party that was formed by the forming player, as well as when there is a request from another player to copy the employed party employed by the one player. This request can be made, for example, from the profile screen of another player, a details screen at the end of a quest, or a party information screen made public by a plurality of players. Examples of other players include the player's friend players, and players included in the matching history of the player information 50A. This request also includes a request to copy the formed party of the forming player, and a request to copy the employed party of the employing player.

Also, for example, the identifying unit 54 identifies the forming player when one player browses a formed party and then that one player forms that formed party in their own party. That is, the identifying unit 54 identifies the forming player when one player browses a formed party of the forming player and then that one player imitates (replicates) that formed party. In the first embodiment, the identifying unit 54 determines that one player has imitated (replicated) the formed party when the combination of characters constituting a party formed by the one player matches the combination of characters constituting that formed party.

An example of this browsing is when a player requests to browse the profile screen of another player, and the party information of that other player (such as images of the characters) is displayed on a touch panel 32 of the player's terminal device 12. Examples of other players include the player's friend players, and players included in the matching history of the player information 50A.

Also, for example, the identifying unit 54 identifies the forming player when yet another player browses an employed party and then that other player forms that employed party in their own party. That is, the identifying unit 54 identifies the forming player when yet another player browses the employed party of the one player (employing player), and then that other player further imitates (replicates) that employed party. In the first embodiment, the identifying unit 54 determines that yet another player has imitated (replicated) the employed party when the combination of characters constituting a party formed by that other player matches the combination of characters constituting that employed party.

Also, for example, the identifying unit 54 identifies the forming player when one player plays a battle game with a formed party, and then that one player forms that formed party in their own party (selects characters). That is, the identifying unit 54 identifies the forming player when one player plays a battle game with a player (the forming player), and then that one player imitates (replicates) that formed party.

Also, for example, the identifying unit 54 identifies the forming player when another player plays a battle game with an employed party, and then that other player forms that employed party in their own party. That is, the identifying unit 54 identifies the forming player when another player plays a battle game with one player (employing player), and then that other player further imitates (replicates) that employed party.

The granting unit 56 is a functional unit for granting various rewards to the player. In the first embodiment, the granting unit 56 grants a reward (employment reward) to the forming player identified by the identifying unit 54. For example, when a forming player is identified in response to an employed party being further employed (copied), the granting unit 56 may grant a reward (employment reward) to that forming player.

Also, for example, the granting unit 56 may grant a reward (employment reward) to the forming player when a battle game is played using a party employed by one player (employing player), or when a battle game is played using a party employed by another player (employing player). For example, the granting unit 56 grants a reward (employment reward) to the forming player at the start or end of a battle game in which a party employed by one player or another player is used.

Also, for example, the granting unit 56 may grant a reward (employment reward) to the forming player when a battle game is won using a party employed by one player (employing player), or when a battle game is won using a party employed by another player (employing player). For example, the granting unit 56 may grant a reward (employment reward) to the forming player when a battle game in which a party employed by one player or another player is used ends, and the one player or the other player wins.

Also, for example, the granting unit 56 may grant a first reward (first employment reward) when one player (employing player) employs a formed party as an employed party, and may grant a second reward (second employment reward) different from the first reward when another player (employing player) further employs the employed party. For example, the first reward and the second reward may have different values. A specific example in which the first reward and the second reward have different values will now be described.

(1) When the First Reward is More Valuable than the Second Reward

For example, the first reward may be of greater value than the second reward. In other words, the first reward may be more advantageous to the player than the second reward. More specifically, the first reward may be 10 units of unpaid currency and the second reward may be 5 units of unpaid currency. Also, for example, the first reward may be a character with a rarity of 5 and the second reward may be a character with a rarity of 4.

(2) When the Second Reward is More Valuable than the First Reward

For example, the second reward may be of greater value than the first reward. In other words, the second reward may be more advantageous to the player than the first reward. More specifically, the first reward may be one gacha ticket for a lottery game in which characters with rarities from 1 to 4 constitute the lottery target character group, and the second reward may be one gacha ticket for a lottery game in which characters with rarities from 2 to 5 constitute the lottery target character group. Also, for example, the first reward may be one stamina restoration item and the second reward may be two stamina restoration items.

The control unit 58 is a functional unit for controlling the entire game. In the first embodiment, the control unit 58 controls the execution of lottery games and quests. For example, at the start of a quest, the control unit 58 may consume the current stamina value or execute matching processing between players.

### Flow of Processing

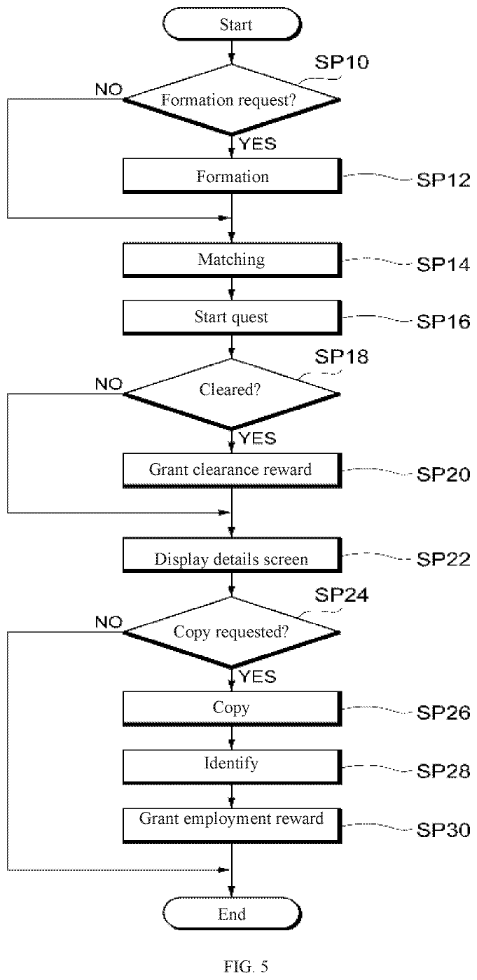

FIG. 5 is a flowchart showing an example of the flow of processing performed by each of the functional units shown in FIG. 4 in the game system according to the first embodiment. Also, the processing of the following steps may be commenced, for example, at the point when one player, as the host of a multiplayer game, selects a quest from the quest menu. The order and details of the following steps can be changed as needed.

### Step SP10

The formation unit 52 determines whether or not there has been a formation request from one player to form a party to be used in a quest. This formation request may be, for example, a request to update the party information in the player information 50A corresponding to one player. Then, if this determination is positive, the processing moves to the processing of step SP12. On the other hand, if the determination is negative, the processing moves to the processing of step SP14.

### Step SP12

The formation unit 52 refers to the possessed character information in the player information 50A corresponding to one player, displays a list screen of characters possessed by the player on the touch panel 32, and accepts a selection instruction to select a specific number of characters (e.g., four) to be formed into a party. Next, the formation unit 52 stores the character IDs of the selected characters in the party information in the player information 50A. Then, the processing moves to the processing of step S14.

### Step SP14

The control unit 58 matches one player with another player who will cooperate with the one player to play a quest (battle game). Examples of this other player include a player who selected a quest as a guest in a multiplayer game at the same time as the one player, a friend player of the player, or a player whose location information is close to that of the one player. Then, the processing moves to the processing of step SP16.

### Step SP16

The control unit 58 starts a quest in which the one player matched in step SP14 and another player participate (multiplayer game). First, the control unit 58 refers to the quest information 50D and consumes a consumed stamina value corresponding to the quest from the current stamina value in the player information 50A corresponding to the one player. Next, the control unit 58 displays a battle game screen on the touch panel 32 of the terminal device 12 owned by the one player and on the touch panel 32 of the terminal device 12 owned by the other player. More specifically, the control unit 58 refers to player information 50A for the one player and player information 50A for the other matched player, and displays images of the characters that constitute each player's party on the battle game screen. Also, the control unit 58 refers to the quest information 50D and causes an image of an enemy character to be displayed on the battle game screen. Then, the processing moves to the processing of step SP18.

### Step SP18

The control unit 58 determines whether or not the one player and the other player have cleared the quest. For example, if the hit points of a boss character appearing in the quest reach zero or less, the control unit 58 makes a positive determination. On the other hand, if the hit points of each character constituting each player's party reach zero or less, the control unit 58 makes a negative determination. If the determination is positive, the processing then moves to the processing of step SP20. On the other hand, if the determination is negative, the processing moves to the processing of step SP22.

### Step SP20

The granting unit 56 refers to the quest information 50D and grants a clearance reward corresponding to the quest to both the one player and the other player. Then, the processing moves to the processing of step SP22.

### Step SP22

The control unit 58 causes a details screen for displaying details of the other player (cooperating player) who cooperated in the quest to be displayed on the touch panel 32 of the terminal device 12 owned by the one player.

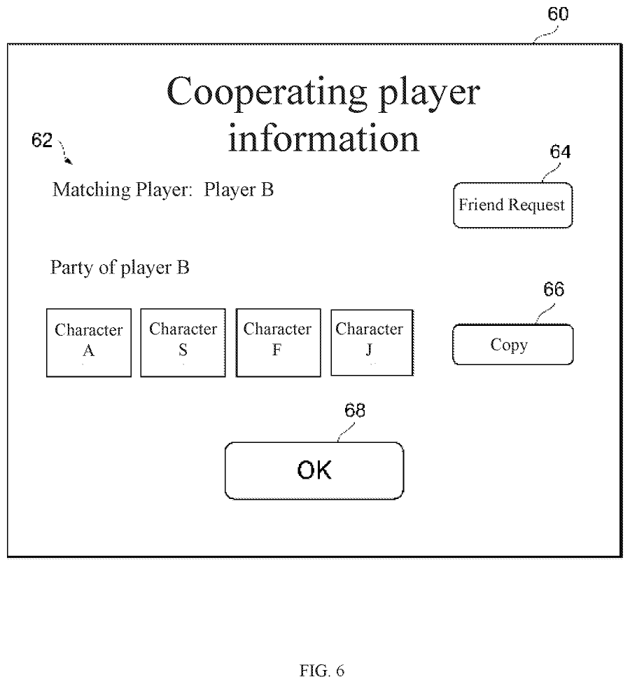

FIG. 6 is a diagram showing an example of a cooperating player details screen 60 according to the first embodiment.

As shown in FIG. 6, the details screen 60 is provided with a cooperating player information area 62, a friend request button 64, a copy button 66, and an OK button 68. In the cooperating player information area 62 are displayed the name of the other player who cooperated in the quest and the party of that other player (images of the characters). The friend request button 64 is a button for sending a friend request to the other player. In the first embodiment, if this friend request is accepted by the other player, the one player and the other player become friend players to each other. The friend request button 64 is not displayed if the one player and the other player are already friend players. The copy button 66 is a button to copy (employ) the other player's party into one player's party. The OK button 68 is a button for ending the quest.

Going back to FIG. 5, the processing moves to the processing of step SP24.

### Step SP24

The formation unit 52 determines whether or not there has been a request from one player to copy (employ) a party of another player in their own party. For example, the formation unit 52 makes a positive determination when the copy button is pressed by the one player. If the determination is positive, the processing then moves to the processing of step SP26. On the other hand, if the determination is negative, that is, if the OK button is pressed without pressing the copy button, the series of processing shown in FIG. 5 ends.

### Step SP26

The formation unit 52 refers to the player information 50A of another player and copies the party information of the other player into the party information in the player information 50A of the one player. That is, the formation unit 52 stores the character IDs of the characters constituting the party of that other player and the forming player ID in the party information of the one player. Consequently, the one player becomes the employing player. Then, the processing moves to the processing of step SP28.

### Step SP28

The identifying unit 54 identifies the forming player (forming player ID) stored in the party information of the one player in step SP26. That is, in response to the one player copying (employing) a party of another player in their own party, the identifying unit 54 identifies the forming player who formed that copied party. For example, the identifying unit 54 identifies another player as the forming player when the one player copies (employs) a formed party formed by the other player as an employed party. Also, the identifying unit 54 identifies a certain player as the forming player when a different player copies (employs) a formed party formed by the certain player as an employed party and that one player further copies (employs) that employed party as an employed party. Then, the processing moves to the processing of step SP30.

### Step SP30

The granting unit 56 grants a reward (employment reward) to the forming player identified in step SP28. In the first embodiment, the granting unit 56 transmits a reward receipt message to the forming player. For example, when the reward receipt message is opened, the control unit 58 may cause the touch panel 32 of the terminal device 12 owned by the forming player to display a reward receipt screen.

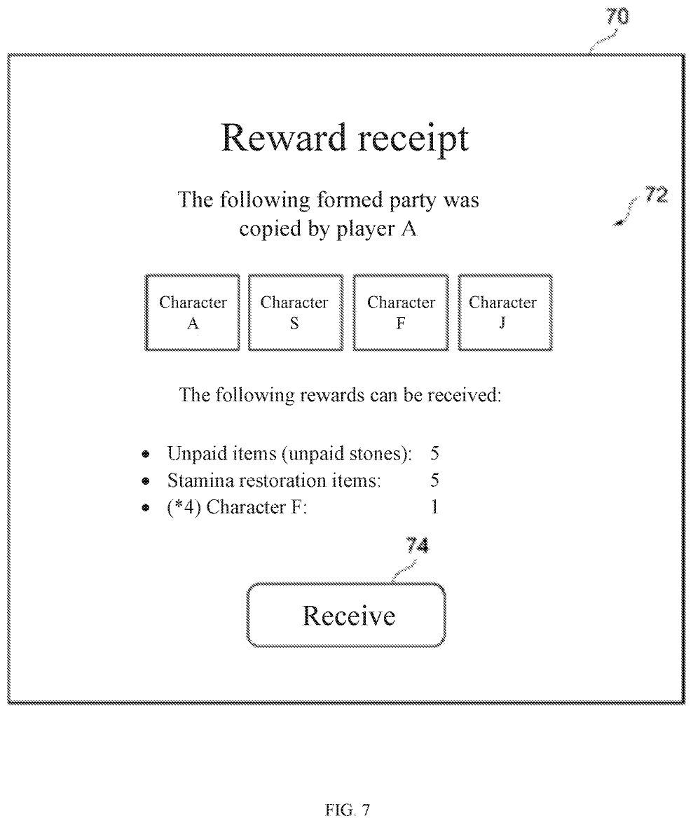

FIG. 7 is a diagram showing an example of a reward receipt screen 70 according to the first embodiment.

As shown in FIG. 7, the reward receipt screen 70 is provided with a reward information area 72 and a receive button 74. The reward information area 72 indicates that a formed party has been copied and the type and amount of reward (employment reward). The receive button 74 is used to confirm the receipt of a reward.

Then, the processing of the processing series shown in FIG. 5 ends.

### Technical Effects

In the first embodiment above, a computer is made to function as a formation unit 52 for forming a party consisting of a specific number of pieces of content selected by a player from among a plurality of pieces of content, a identifying unit 54 for identifying a forming player who formed the formed party when one player employs that formed party as an employed party in their own party, and a granting unit 56 for granting a reward to the identified forming player, wherein the identifying unit 54 also identifies the forming player even when another player further employs the employed party in their own party.

With this configuration, a reward is also granted to the forming player who formed the formed party even when the employed party is further employed. A player (the forming player) whose formed party has been propagated can thereby be motivated to play the game.

Also, in the first embodiment, the identifying unit 54 identifies the forming player when there is a request from one player to copy the formed party, as well as when there is a request from another player to copy the employed party.

With this configuration, a reward is granted to the player who formed the formed party (the player who reduced the work of an employing player) even when the employed party is further copied. A player (the forming player) whose formed party has been propagated can thereby be motivated to play the game.

Also, in the first embodiment, the identifying unit 54 identifies the forming player when one player browses a formed party and then that one player forms that formed party in their own party, and the identifying unit 54 identifies the forming player when another player browses the employed party and then that other player forms that employed party in their own party.

With this configuration, when a party is browsed and imitated (replicated), a reward is granted to the forming player (the player who contributed to the party formation of an employing player). A player (the forming player) whose formed party has been propagated can thereby be motivated to play the game.

Also, in the first embodiment, the identifying unit 54 identifies the forming player when one player plays a battle game with a formed party and then the one player forms that formed party in their own party, and the identifying unit 54 identifies the forming player when another player plays a battle game with the employed party and then that other player forms that employed party in their own party.

With this configuration, when a party is imitated (replicated) after a battle game is played, a reward is granted to the forming player (the player who contributed to the party formation of an employing player). A player (the forming player) whose formed party has been propagated can thereby be motivated to play the game.

Also, in the first embodiment, the granting unit 56 grants a reward to the forming player when one player plays a battle game using an employed party, or when another player plays a battle game using the employed party.

With this configuration, a reward is granted when the formed party or the employed party is employed and a battle game is played. A player whose formed party has been propagated (the player who contributed to the execution of the battle game by an employing player) can thereby be motivated to play the game. Also, it is less likely that excessive rewards will be granted to a player whose formed party has been propagated.

Also, in the first embodiment, the granting unit 56 grants a reward to the forming player when one player wins a battle game using the employed party, or when another player wins a battle game using the employed party.

With this configuration, a reward is granted when the formed party or the employed party is employed and a battle game is won. A player whose formed party has been propagated (the player who contributed to the employing player's victory in the battle game) can thereby be motivated to play the game. Also, it is less likely that excessive rewards will be granted to a player whose formed party has been propagated.

Also, in the first embodiment, the granting unit 56 grants a first reward when one player employs the formed party as an employed party, and grants a second reward different from the first reward when another player further employs the employed party.

With this configuration, the rewards are different when a formed party is employed and when an employed party is further employed, which encourages the player (the forming player) to be strategic when forming a party, thereby making the game more exciting.

Also, in the first embodiment, the first reward may be of greater value than the second reward.

With this configuration, when a formed party is employed, a high-value reward (first reward) is granted, which motivates the player (the forming player) to use the formed party to connect with many players, make the formed party public, etc., and this makes the game more exciting.

Also, in the first embodiment, the second reward may be of greater value than the first reward.

With this configuration, when an employed party is further employed, a high-value reward (second reward) is granted, which motivates the player (the forming player) to form a party that will be employed a number of times, and this makes the game more exciting.

### Second Embodiment

A second embodiment will now be described.

The second embodiment differs from the first embodiment in that the player information 50A includes an accumulated value, and the granting unit 56 grants a reward (employment reward) to the forming player according to the accumulated value, and so forth. Aspects of the configuration and functions of the game system according to the second embodiment that are the same as those of the game system according to the first embodiment are omitted from the description below.

In the second embodiment, the player information 50A may include an accumulated value, for example. This accumulated value accumulates (increases) when a formed party that has been formed by a player is employed by another player as an employed party, or when that employed party is further employed. In the second embodiment, the accumulated value may be initialized to 0 (zero) at the start or end of a specific period (such as an event period).

In the second embodiment, the granting unit 56 accumulates an accumulated value corresponding to the forming player due to the identifying of the forming player by the identifying unit 54. For example, when the forming player is identified in response to an employed party being further employed (copied), the granting unit 56 accumulates an accumulated value corresponding to that forming player. Also, the granting unit 56 grants a reward (employment reward) to the forming player according to the accumulated value. For example, the granting unit 56 may grant a reward to the forming player every time the accumulated value reaches a multiple of ten. Also, for example, the granting unit 56 may grant a reward of higher value as the accumulated value increases. More specifically, the granting unit 56 may grant one unit of unpaid currency when the accumulated number reaches a multiple of 10 that is less than 100, two units of unpaid currency when the accumulated number reaches a multiple of 10 between 100 and 300, and three units of unpaid currency when the accumulated number reaches a multiple of 10 that is greater than 300.

Also, the granting unit 56 accumulates a first specific value in the accumulated value when one player employs a formed party as an employed party, and accumulates a second specific value in the accumulated value when another player further employs the employed party. The first specific value and the second specific value may be different values. For example, the first specific value may be greater than the second specific value. More specifically, the first specific value may be the product obtained by multiplying the second specific value by a value (coefficient) greater than 1. For instance, if the first specific value is 2, the second specific value might be 1. Alternatively, the second specific value may be greater than the first specific value, for example. More specifically, the second specific value may be the product obtained by multiplying the first specific value by a value (coefficient) greater than 1. For instance, if the first specific value is 2, the second specific value might be 3.

### Flow of Processing

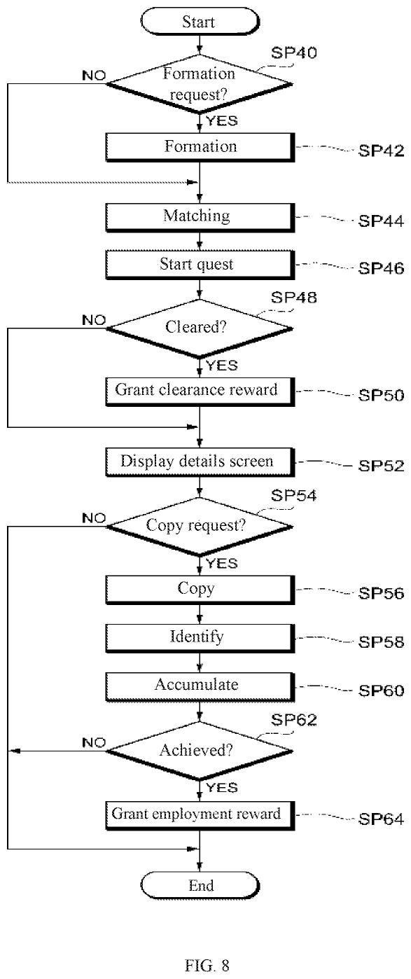

FIG. 8 is a flowchart showing an example of the flow of processing performed by each of the functional units in the game system according to the second embodiment. Also, the processing of the following steps may be commenced, for example, at the point when one player, as the host of a multiplayer game, selects a quest from the quest menu. The order and details of the following steps can be changed as needed.

### Steps SP40 to SP58

The processing of steps SP40 to SP58 is the same as the processing of steps SP10 to SP28 above, and therefore will not be described again. Then, the processing moves to the processing of step SP60.

### Step SP60

The granting unit 56 accumulates an accumulated value corresponding to the forming player identified in step SP58. For example, when one player employs a formed party as an employed party, the granting unit 56 may accumulate (add) a first specific value (such as 2) to the accumulated value of the player information 50A for the forming player. Also, for example, when one player further employs an employed party as an employed party, the granting unit 56 may accumulate (add) a second specific value (such as 1) to the accumulated value of the player information 50A for the forming player. Then, the processing moves to the processing of step SP62.

### Step SP62

The granting unit 56 determines whether or not the accumulated value accumulated in step SP60 has reached a specific value. This specific value may be a multiple of 10 (10, 20, . . . ). If the determination is positive, the processing then moves to the processing of step SP64. On the other hand, if the determination is negative, the processing of the processing series shown in FIG. 8 ends.

### Step SP64

The granting unit 56 grants a reward (employment reward) to the forming player. In the second embodiment, the granting unit 56 transmits a reward receipt message to the forming player. For example, when the reward receipt message is opened, the control unit 58 may cause a reward receipt screen to be displayed on the touch panel 32 of the terminal device 12 owned by the forming player.

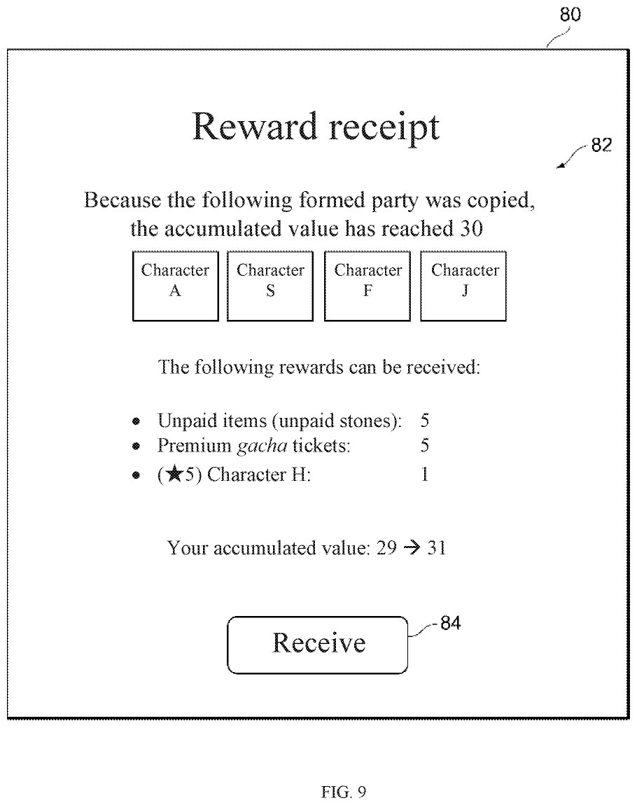

FIG. 9 is a diagram showing an example of a reward receipt screen 80 according to the second embodiment.

As shown in FIG. 9, the reward receipt screen 80 is provided with a reward notification information area 82 and a receive button 84. The reward information area 82 indicates that the accumulated value has reached a specific value due to the copying of a formed party, the type and quantity of reward (employment reward), and the current accumulated value.

Then, the processing of the processing series shown in FIG. 8 ends.

### Technical Effects

In the second embodiment above, a computer is made to function as a formation unit 52 for forming a party consisting of a specific number of pieces of content selected by a player from among a plurality of pieces of content, a identifying unit 54 for identifying a forming player who formed the formed party when one player employs that formed party as an employed party in their own party, and a granting unit 56 for accumulating an accumulated value corresponding to the forming player due to the identifying and for granting a reward to the forming player according to that accumulated value, wherein the identifying unit 54 also identifies the forming player even when another player further employs the employed party in their own party.

With this configuration, the accumulated value is also accumulated and a reward is granted to the forming player who formed the formed party even when the employed party is further employed. A player (the forming player) whose formed party has been propagated can thereby be motivated to play the game.

Also, in the second embodiment, the identifying unit 54 identifies the forming player when there is a request from one player to copy a formed party, as well as when there is a request from another player to copy an employed party.

With this configuration, when an employed party is further copied, the accumulated value is also accumulated and a reward is granted to the forming player who formed that formed party (the player who reduced the work of the employing player). A player (the forming player) whose formed party has been propagated can thereby be motivated to play the game

Also, in the second embodiment, the identifying unit 54 identifies the forming player when one player browses a formed party and then that one player forms that formed party in their own party, and the identifying unit 54 identifies the forming player when another player browses the employed party and then that other player forms that employed party in their own party.

With this configuration, when a party is browsed and imitated (replicated), a reward is granted to the forming player (the player who contributed to the party formation of an employing player). A player whose formed party has been propagated can thereby be motivated to play the game.

Also, in the second embodiment, the identifying unit 54 identifies the forming player when one player plays a battle game with a formed party and then that one player forms that formed party in their own party, and the identifying unit 54 identifies the forming player when another player plays a battle game with an employed party and then that other player forms that employed party in their own party.

With this configuration, when a party is imitated (replicated) after a battle game is played, a reward is granted to the forming player (the player who contributed to the party formation of the employing player). A player whose formed party has been propagated can thereby be motivated to play the game.

Also, in the second embodiment, the granting unit 56 grants a reward to a forming player when a battle game is played using a party employed by one player, or when a battle game is played using a party employed by another player.

With this configuration, a reward is granted when a formed party or an employed party is employed and a battle game is played. A player whose formed party has been propagated (the player who contributed to the execution of the battle game by the employing player) can thereby be motivated to play the game. Also, it is less likely that an excessive reward will be granted to a player whose formed party has been propagated.

Also, in the second embodiment, the granting unit 56 grants a reward to a forming player when a battle game is won using a party employed by one player, or when a battle game is won using a party employed by another player.

With this configuration, a reward is granted when the formed party or the employed party is employed and a battle game is won. A player whose formed party has been propagated (the player who contributed to the employing player's victory in the battle game) can thereby be motivated to play the game. Also, it is less likely that an excessive reward will be granted to a player whose formed party has been propagated.

Also, in the second embodiment, the granting unit 56 accumulates a first specific value in the accumulated value when one player employs a formed party as an employed party, and accumulates a second specific value that is a different value from the first specific value in the accumulated value when another player further employs the employed party.

With this configuration, the accumulated values are different when a formed party is employed and when the employed party is further employed, which encourages the player (the forming player) to be strategic when forming a party, thereby making the game more exciting.

In the second embodiment, the granting unit 56 grants a reward of higher value in proportion to how high the accumulated value is, and the first specific value may be greater than the second specific value.

With this configuration, since there are more accumulated values when a formed party is employed, this motivates the player (the forming player) to use the formed party to connect with more players, make the formed party public, etc., and this makes the game more exciting.

In the second embodiment, the granting unit 56 grants a reward of higher value in proportion to how high the accumulated value is, and the second specific value may be greater than the first specific value.

With this configuration, when an employed party is further employed, there are more accumulated values, which motivates the player (the forming player) to form a party that will be employed a number of times, and this makes the game more exciting.

### Modifications

The present invention is not limited to or by the above specific examples. That is, suitable design changes made to the above specific examples by a person skilled in the art are also encompassed by the scope of the present invention as long as they still have the features of the present invention. Also, the elements of the embodiments described above and the modified examples (discussed below) can be combined to an extent that this is technically possible, and these combinations are also encompassed by the scope of the present invention as long as they still have the features of the present invention.

For example, in the first embodiment, a situation was described in which the identifying unit 54 determined that an imitation (replication) had occurred when the characters constituting a party formed by one player or another player matched the combination of characters constituting a party that was browsed or a party with which a battle game was played, but this determination may also be made when only a portion of the combination (more than half, for example) matches. Also, the identifying unit 54 may make this determination when there is a match in some or all of the order in which the characters constituting a party formed by one player are lined up or arranged. Also, the identifying unit 54 may determine that imitation (replication) has occurred when a player browses another player's party and then forms a party with the same combination within a specific period of time (such as one week). Similarly, the identifying unit 54 may determine that imitation (replication) has occurred when a player plays a battle game with another player's party, and then forms a party with the same combination within a specific period of time (such as one week).

Also, in the first embodiment, a situation was described in which the formation unit 52 formed a party consisting of a specific number of characters selected by the player from among a plurality of characters possessed by the player, but the characters that the player can select from among the plurality of characters may also include characters loaned by other players (loaned characters) and characters provided by the game operator (provided characters).

Also, in the first embodiment, a situation was described in which the granting unit 56 granted a reward (employment reward) when a formed party or an employed party was employed (e.g., copied), but if the employing player newly employs a different party within a specific period (such as 24 hours) after this reward has been granted, the reward may not be granted.

Similarly, in the second embodiment, a situation was described in which the granting unit 56 accumulated accumulation values when a formed party or an employed party was employed (e.g., copied), but if the employing player newly employs a different party within a specified period (such as 24 hours) after this accumulation, the accumulation may not be performed.

Also, in the first embodiment, a situation was described in which the granting unit 56 granted rewards of different values (first employment reward and second employment reward), but the type of reward may be changed depending on the number of times the reward has been granted to the same player in the past.

Also, in the first embodiment, a situation was described in which the granting unit 56 granted a reward (employment reward) to the forming player, but a reward may also be granted to an employing player when that employing player's employed party is employed. Also, for example, the granting unit 56 may grant different rewards to the employing player and the forming player. For example, the reward granted to an employing player may be of lower value than the reward granted to a forming player.

Also, in the first embodiment, a situation was described in which the reward (employment reward) was mainly content, but it may instead be an effect of increasing a parameter related to the forming player (such as stamina), an effect of increasing ability parameters or the like of the characters that constitute the forming player's party, an effect of increasing the reward for clearing a quest, an effect of relaxing the restrictions imposed on the forming player, or the like. Examples of these restrictions could include the maximum number of times a quest can be performed, the maximum number of times a lottery game can be played, the maximum amount of content that can be acquired, the maximum number of items that can be used, and so forth.

Also, in the second embodiment, a situation was described in which the granting unit 56 granted a reward of higher value in proportion to how high the accumulated value was, but a reward of lower value may be granted in proportion to how high the accumulated value is.

Also, in the second embodiment, a situation was described in which the granting unit 56 granted a reward to the forming player every time the accumulated value reached a multiple of 10, but the reward may instead be granted based on a table in which the type of reward to be granted corresponds to the accumulated value.

Also, in the second embodiment, a situation was described in which the accumulated value was initialized at the start or end of a specified period, but this accumulated value may instead be initialized when a player with whom the accumulated value is associated changes (re-forms or employs) their own party (formed party).

Also, in the first and second embodiments, a situation was described in which a party of another player was employed, but a player may employ a party they proposed (formed) on their own.

Also, in the first and second embodiments, a situation was described in which a party consisted of a specific number of characters (e.g., four), but a party may consist of fewer than the specific number of characters.

Also, in the first and second embodiments, a situation was described in which the party information in the player information 50A included the character IDs of the characters constituting one party, but may instead include the character IDs of the characters constituting a plurality of parties. For example, when a player browses a party of another player, a plurality of parties associated with that other player can be browsed.

Also, in the first and second embodiments, a situation was described in which a quest was a battle game (cooperative game) in which a party of one player cooperates with a party of another player (cooperating player) matched with that one player, but the quest may instead be a battle game in which a party of one player battles against a party of another player. Also, a quest may also be a multiplayer (battle royale) battle game in which three or more players participate.

Also, in the first embodiment and the second embodiment, a case was described in which the content was mainly characters, but the content may instead be various items such as weapons or armor, cards, avatars, coins, points, etc.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10 . . . server device (computer), 12 . . . terminal device, 50 . . . storage unit, 52 . . . formation unit, 54 . . . identifying unit, 56 . . . granting unit

What is claimed is:

1. A non-transitory computer readable recording medium storing instructions for a video game that cause a computer to execute:
receiving an input signal from a first player for forming a party consisting of one or more pieces of game content;
in response to a second player employing the formed party, identifying the first player who formed the formed party; and
in response to the second player employing the formed party, and in response to a third player also employing the formed party after being employed by the second player, granting a reward to the identified first player.

2. The non-transitory computer readable recording medium according to claim 1, wherein
the identifying includes identifying the first player in response to a request from the second player to copy the formed party, and in response to a request from the third player to copy the employed party.

3. The non-transitory computer readable recording medium according to claim 1, wherein
the identifying includes identifying the first player in response to the second player browsing the formed party and then forming the formed party in their own party, and
the identifying includes identifying the first player in response to the third player browsing the employed party and then forming the employed party in their own party.

4. The non-transitory computer readable recording medium according to claim 1, wherein
the identifying includes identifying the first player in response to the second player playing a battle game with the formed party and then forming the formed party in their own party, and
the identifying includes identifying the first player in response to the third player playing a battle game with the employed party and then forming the employed party in their own party.

5. The non-transitory computer readable recording medium according to claim 2, wherein
the granting includes granting the reward to the first player in response to the second player playing a battle game using the employed party, or in response to the third player playing a battle game using the employed party.

6. The non-transitory computer readable recording medium according to claim 5, wherein
the granting includes granting the reward to the first player in response to the second player winning a battle game using the employed party, or in response to the third player winning a battle game using the employed party.

7. The non-transitory computer readable recording medium according to claim 1, wherein
the granting includes granting a first reward in response to the second player employing the formed party as an employed party, and granting a second reward different from the first reward in response to the third player employing the employed party.

8. The non-transitory computer readable recording medium according to claim 7, wherein
the first reward is of greater value than the second reward.

9. The non-transitory computer readable recording medium according to claim 7, wherein
the second reward is of greater value than the first reward.

10. An information processing device for a video game, comprising:
a central processing unit (CPU) that:
receives an input signal from a first player for forming a party consisting of one or more pieces of game content,
in response to a second player employing the formed party, identifies the first player who formed the formed party, and
in response to the second player employing the formed party, and in response to a third player also employing the formed party after being employed by the second player, grants a reward to the identified first player.

11. The non-transitory computer readable recording medium according to claim 1, wherein
the computer further executes:
storing, for each player, party information including character ID and player ID, and
the employing of the formed party includes copying the character ID and the player ID of the first player in the party information for the second player or the third player.

12. The non-transitory computer readable recording medium according to claim 11, wherein
a request from the second player or the third player to employ the formed party is made from at least one of a profile screen, a details screen displayed at an end of a quest, and a party information screen, on a display.
